(19) United States
(12) Patent Application Publication
(10) Pub. No.: US 2026/0203110 A1
(43) Pub. Date: Jul. 16, 2026

(54) SYSTEM AND METHOD FOR PERFORMING EXPOSURE ASSESSMENT TO AUTOMATICALLY GENERATE AND EXECUTE RULES ASSOCIATED WITH ALLOCATION OF RESOURCES

(71) Applicant: BANK OF AMERICA CORPORATION, Charlotte, NC (US)

(72) Inventors: Kaustav Kumar De, Noida (IN); Shailendra Singh, Thane West (IN); Satya Murthy Yenamandra, Hyderabad (IN)

(73) Assignee: BANK OF AMERICA CORPORATION, Charlotte, NC (US)

(21) Appl. No.: 19/025,178

(22) Filed: Jan. 16, 2025

(51) Int. Cl. G06F 9/50; G06F 21/62

(52) U.S. Cl. CPC G06F 9/5005; G06F 21/6254

(57) ABSTRACT

Embodiments of the present invention provide a system for performing exposure assessment to automatically generate and execute rules associated with allocation of resources. In particular, the system may be configured to receive a request for allocation of resources from a user, where the allocation of resources is associated with acquisition of a unit, prompt the user to register the unit, gather unit information associated with the unit, anonymize the unit information and transmit the anonymized unit information to an artificial intelligence engine, determine, via the artificial intelligence engine, exposure factors associated with the unit and the allocation of resources towards acquisition of the unit, dynamically generate one or more rules based on the exposure factors, and automatically execute a smart contract associated with the allocation of resources based on the one or more rules associated with the allocation of resources.

### BACKGROUND

There exists a need for a system for performing exposure assessment to automatically generate and execute rules associated with allocation of resources.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for performing exposure assessment to automatically generate and execute rules associated with allocation of resources. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives a request for allocation of resources from a user, where the allocation of resources is associated with acquisition of a unit, prompts the user to register the unit, gathers unit information associated with the unit, anonymizes the unit information and transmit the anonymized unit information to an artificial intelligence engine, determines, via the artificial intelligence, one or more exposure factors associated with the unit and the allocation of resources towards acquisition of the unit, dynamically generates one or more rules associated with the allocation of resources associated with the acquisition of the unit based on the one or more exposure factors, and automatically executes a smart contract associated with the allocation of resources based on the one or more rules associated with the allocation of resources.

In some embodiments, the present invention gathers information associated with the unit based on performing one or more of communicating with third party entity systems associated with the unit to extract the information associated with the unit and communicating with one or more sensors associated with the unit to extract the information associated with the unit in real-time.

In some embodiments, the one or more sensors are part of the unit.

In some embodiments, the one or more sensors are external sensors linked with the unit.

In some embodiments, the present invention receives anonymized data associated with the unit from one or more data sources; and transmits the anonymized data to the artificial intelligence engine for determination of the one or more factors.

In some embodiments, the present invention monitors the unit via the one or more sensors, generates one or more measures associated with the smart contract or the unit based on monitoring the unit, and automatically executes at least one measure of the one or more measures.

In some embodiments, the unit is an operational unit or a non-operational unit.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for performing exposure assessment to automatically generate and execute rules associated with allocation of resources, in accordance with an embodiment of the invention;

FIG. 2 provides a block diagram illustrating the entity system 200 of FIG. 1, in accordance with an embodiment of the invention;

FIG. 3 provides a block diagram illustrating a rule generation and execution system 300 of FIG. 1, in accordance with an embodiment of the invention;

FIG. 4 provides a block diagram illustrating the computing device system 400 of FIG. 1, in accordance with an embodiment of the invention; and

FIG. 5 provides a process flow for performing exposure assessment to automatically generate and execute rules associated with allocation of resources, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that executes one or more smart contracts. In some embodiments of the invention, the entity may be any organization that allocates resources to one or more users via smart contracts, where resources may be utilized by the users to acquire one or more units. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

“Distributed register,” as used herein may also be referred to as a “distributed ledger,” as used herein may refer to a structured list of data records that is decentralized and distributed amongst a plurality of computing systems and/or devices. In some embodiments, the distributed ledger may use a linked block structure.

“Linked block,” “linked block structure,” “linked structure,” or “blockchain” as used herein may refer to a data structure which may comprise a series of sequentially linked “blocks,” where each block may comprise data and metadata. The “data” within each block may comprise one or more “data record” or “transactions,” while the “metadata” within each block may comprise information about the block, which may include a timestamp, a hash value of data records within the block, a pointer (e.g., a hash value) to the previous block in the linked block structure, and/or any additional data created by the system of the present invention. In this way, beginning from an originating block (e.g., a “genesis block”), each block in the linked block structure is linked to another block via the pointers within the block headers. If the data or metadata within a particular block in the linked block structure becomes corrupted or modified, the hash values found in the header of the affected block and/or the downstream blocks may become mismatched, thus allowing the system to detect that the data has been corrupted or modified. In some embodiments of the present invention, a user may submit data associated with the creation of a new block associated with the linked block structure. For example, a user may initiate a transaction, where the data associated with the transaction is stored in a new block linked with the transaction.

A “linked block ledger” may refer to a distributed ledger which uses linked block data structures. Generally, a linked block ledger is an “append only” ledger in which the data within each block within the linked block ledger may not be modified after the block is added to the linked block ledger; data may only be added in a new block to the end of the linked block ledger. In this way, the linked block ledger may provide a practically immutable ledger of data records over time.

“Permissioned distributed ledger” as used herein may refer to a linked block ledger for which an access control mechanism is implemented such that only known, authorized users may take certain actions with respect to the linked block ledger (e.g., add new data records, participate in the consensus mechanism, or the like). Accordingly, “unpermissioned distributed ledger” as used herein may refer to a linked block ledger without an access control mechanism.

“Private distributed ledger” as used herein may refer to a linked block ledger accessible only to users or devices that meet specific criteria (e.g., authorized users or devices of a certain entity or other organization). Accordingly, a “public distributed ledger” is a linked block ledger accessible by any member or device in the public realm. In some embodiments of the present invention, the distributed ledger being described herein may be a permissioned distributed ledger. In some embodiments of the present invention, the distributed ledger being described herein may be a private distributed ledger.

“Node” as used herein may refer to a computing system on which the distributed ledger is hosted. In some embodiments, each node maintains a full copy of the distributed ledger. In this way, even if one or more nodes become unavailable or offline, a full copy of the distributed ledger may still be accessed via the remaining nodes in the distributed ledger system. That said, in some embodiments, the nodes may host a hybrid distributed ledger such that certain nodes may store certain segments of the linked block ledger but not others.

“Consensus,” “consensus algorithm,” or “consensus mechanism” as used herein may refer to the process or processes by which nodes come to an agreement with respect to the contents of the distributed ledger. Changes to the ledger (e.g., addition of data records) may require consensus to be reached by the nodes in order to become a part of the authentic version of the ledger. In this way, the consensus mechanism may ensure that each node maintains a copy of the distributed ledger that is consistent with the copies of the distributed ledger hosted on the other nodes; if the copy of the distributed ledger hosted on one node becomes corrupted or compromised, the remaining nodes may use the consensus algorithm to determine the “true” version of the distributed ledger. The nodes may use various different mechanisms or algorithms to obtain consensus, such as proof-of-work (“PoW”), proof-of-stake (“PoS”), practical byzantine fault tolerance (“PBFT”), proof-of-authority (“PoA”), or the like.

“Smart contract” as used herein may refer to executable computer code or logic that may be executed according to an agreement between parties upon the occurrence of a condition precedent (e.g., a triggering event such as the receipt of a proposed data record). In some embodiments, the smart contract may be self-executing code that is stored in the distributed ledger, where the self-executing code may be executed when the condition precedent is detected by the system on which the smart contract is stored.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, allocation and distribution of resources to users for acquiring one or more units (e.g., any operational units, nonoperational units, and/or the like) is based on a static analysis of the units. Examples of units may comprise, but are not limited to, automobiles, aircrafts, appliances, machinery, electronic devices, units comprising perishable products (e.g., expensive perishable food products) or non-perishable products (e.g., container with expensive paintings), properties such as land, house, or the like, etc. However, such an analysis will result in static calculations associated with allocation of resources, thereby resulting in inaccurate exposure assessment and inefficient execution time associated with allocation and distribution of resources. There exists a need for a system that overcomes these problems and provides an efficient way to generate and execute rules associated with allocation of resources to users for acquiring one or more units. The system of the present invention solves this problem as discussed in detail below.

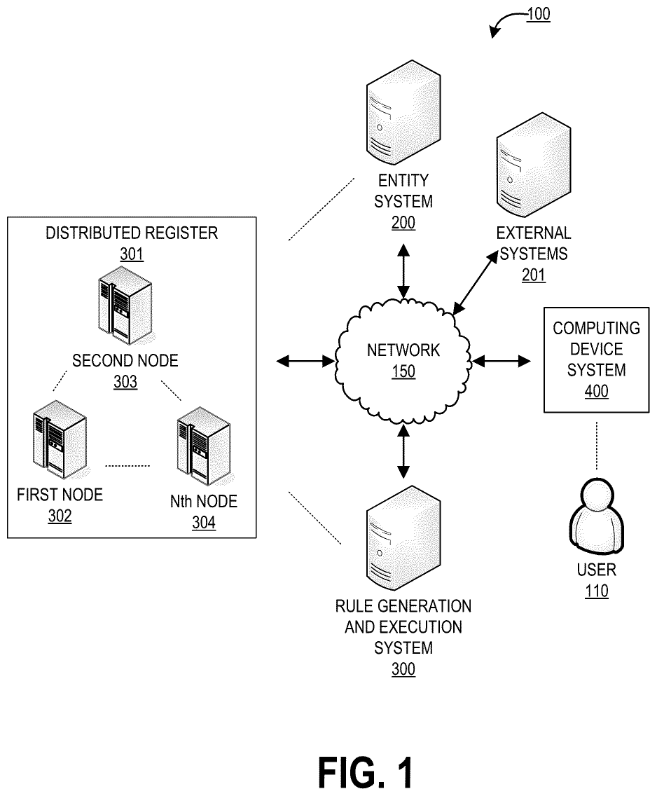

FIG. 1 provides a block diagram illustrating a system environment 100 for performing exposure assessment to automatically generate and execute rules associated with allocation of resources, in accordance with an embodiment of the invention. As illustrated in FIG. 1, the environment 100 includes an rule generation and execution system 300, entity system 200, external systems 201, one or more entity devices 201, a distributed register 301, and a computing device system 400. One or more users 110 may be included in the system environment 100, where the users 110 interact with the other entities of the system environment 100 via a user interface of the computing device system 400. In some embodiments, the one or more users 110 may be employees of the entity.

The entity system(s) 200 may be any system owned or otherwise controlled by an entity to support or perform one or more process steps described herein. In some embodiments, the entity may be any organization that executes one or more smart contracts. In some embodiments of the invention, the entity may be any organization that allocates resources to one or more users via smart contracts, where resources may be utilized by the users to acquire one or more units. In some embodiments, the entity is a financial institution. In some embodiments, the entity is a non-financial institution. In some embodiments, the external systems 201 may be any third party systems that are associated with the one or more units or provide any information associated with the one or more units described herein.

The rule generation and execution system 300 is a system of the present invention for performing one or more process steps described herein. In some embodiments, the rule generation and execution system 300 may be an independent system. In some embodiments, the rule generation and execution system 300 may be a part of the entity system 200.

In some embodiments, the distributed register 301 comprises one or more nodes (e.g., first node 302, second node 303, through nth node). In some embodiments, the distributed register 301 may be a private distributed register associated with the entity. In some embodiments, the distributed register 301 may be a public distributed register. In some embodiments, one or more of the rule generation and execution system 300, the entity system 200, the external systems 201, and the computing device system 400 may be one or more nodes of the distributed register 301.

The rule generation and execution system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the rule generation and execution system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the rule generation and execution system 300, and/or entity system 200 across the network 150. In some embodiments of the invention, the computing device system 400 may be a mobile device.

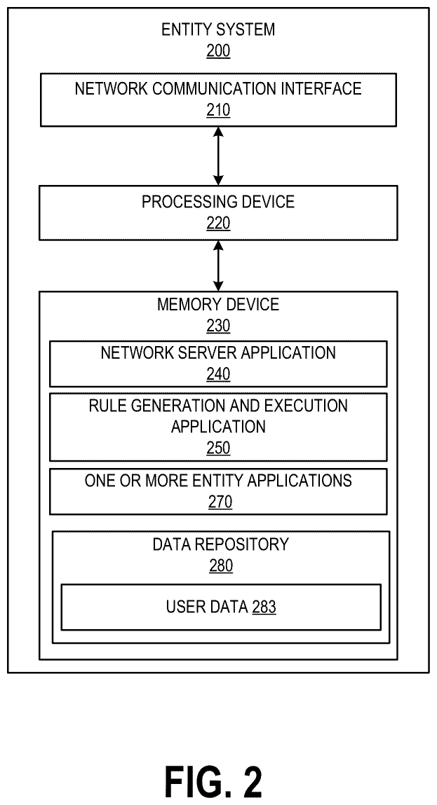

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an rule generation and execution application 250, one or more entity applications 270, and a data repository 280 comprising user data 283 and unit data (not shown) associated with units acquired by the users 110, where the user data 283 comprises data associated with users 110 (e.g., any data associated with financial accounts, employment associated with the users 110, personal information, and/or the like). The one or more entity applications 270 may be any applications provided by the entity that allows users 110 to access information and/or perform one or more actions associated with one or more datafiles of one or more users of the distributed register based entity network created by the system of the present invention. The computer-executable program code of the network server application 240, the rule generation and execution application 250, the one or more entity application 270 to perform certain logic, data-extraction, and data-storing functions of the entity system 200 described herein, as well as communication functions of the entity system 200.

The network server application 240, the rule generation and execution application 250, and the one or more entity applications 270 are configured to store data in the data repository 280 or to use the data stored in the data repository 280 when communicating through the network communication interface 210 with the rule generation and execution system 300, and/or the computing device system 400 to perform one or more process steps described herein. In some embodiments, the entity system 200 may receive instructions from the rule generation and execution system 300 via the rule generation and execution application 250 to perform certain operations. The rule generation and execution application 250 may be provided by the rule generation and execution system 300.

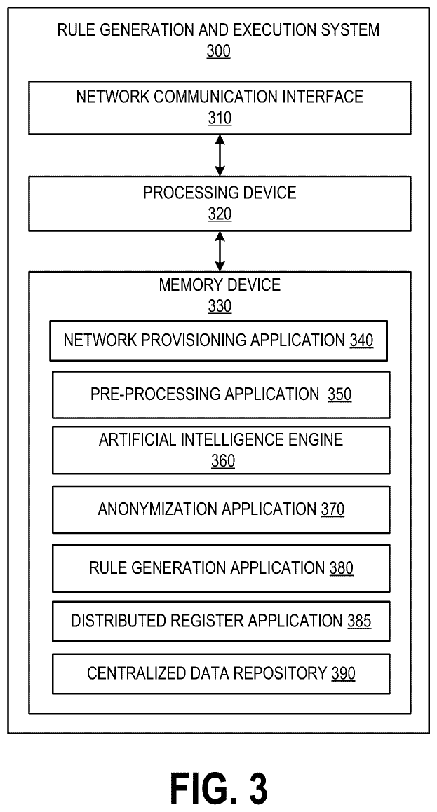

FIG. 3 provides a block diagram illustrating the rule generation and execution system 300 in greater detail, in accordance with embodiments of the invention. As illustrated in FIG. 3, in one embodiment of the invention, the rule generation and execution system 300 includes one or more processing devices 320 operatively coupled to a network communication interface 310 and a memory device 330. In certain embodiments, the rule generation and execution system 300 is operated by a first entity, such as a financial institution, while in other embodiments, the rule generation and execution system 300 is operated by an entity other than a financial institution. In some embodiments, the rule generation and execution system 300 is owned or operated by the entity of the entity system 200. In some embodiments, the rule generation and execution system 300 may be an independent system. In alternate embodiments, the rule generation and execution system 300 may be a part of the entity system 200.

It should be understood that the memory device 330 may include one or more databases or other data structures/repositories. The memory device 330 also includes computer-executable program code that instructs the processing device 320 to perform one or more operations described herein and also to operate the network communication interface 310 to perform certain communication functions of the rule generation and execution system 300 described herein. For example, in one embodiment of the rule generation and execution system 300, the memory device 330 includes, but is not limited to, a network provisioning application 340, a pre-processing application 350, an artificial intelligence engine 360, an anonymization application 370, a rule generation application 380, a distributed register application 385, and a centralized data repository 390 comprising data processed or accessed by one or more applications in the memory device 330. The computer-executable program code of the network provisioning application 340, the pre-processing application 350, the artificial intelligence engine 360, the anonymization application 370, the rule generation application 380, the distributed register application 385 may instruct the processing device 320 to perform certain logic, data-processing, and data-storing functions of the rule generation and execution system 300 described herein, as well as communication functions of the rule generation and execution system 300.

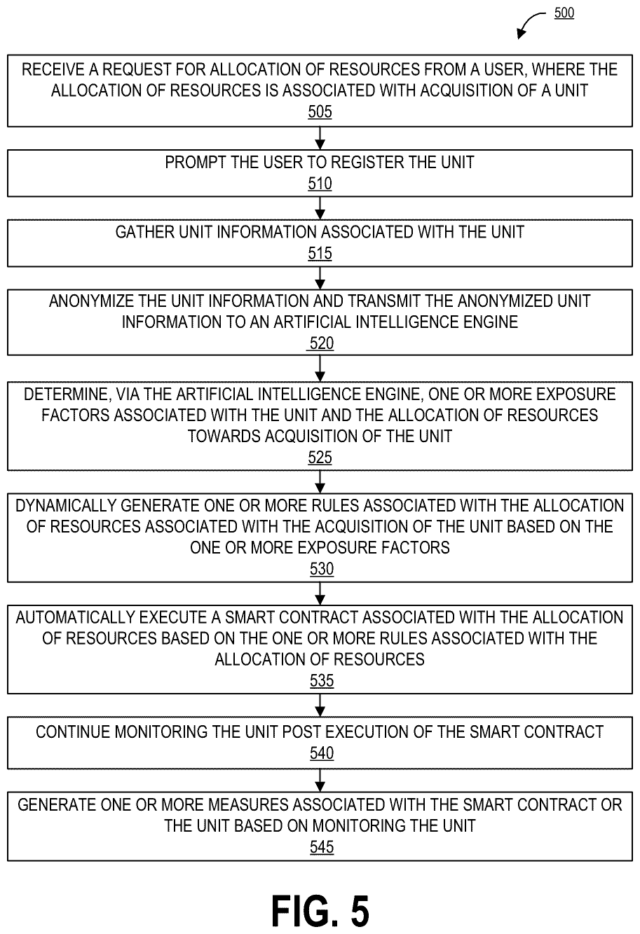

The network provisioning application 340 the pre-processing application 350, the artificial intelligence engine 360, the anonymization application 370, the rule generation application 380, the distributed register application 385 are configured to invoke or use the data in the data repository 390 when communicating through the network communication interface 310 with the entity system 200, and/or the computing device system 400. In some embodiments, the network provisioning application 340, the pre-processing application 350, the artificial intelligence engine 360, the anonymization application 370, the rule generation application 380, the distributed register application 385 may store the data extracted or received from the entity system 200, and the computing device system 400 in the centralized data repository 390. In some embodiments, the network provisioning application 340, the pre-processing application 350, the artificial intelligence engine 360, the anonymization application 370, the rule generation application 380, the distributed register application 385 may be a part of a single application. The functionalities of the network provisioning application 340, the pre-processing application 350, the artificial intelligence engine 360, the anonymization application 370, the rule generation application 380, the distributed register application 385 are explained in greater detail in FIG. 5.

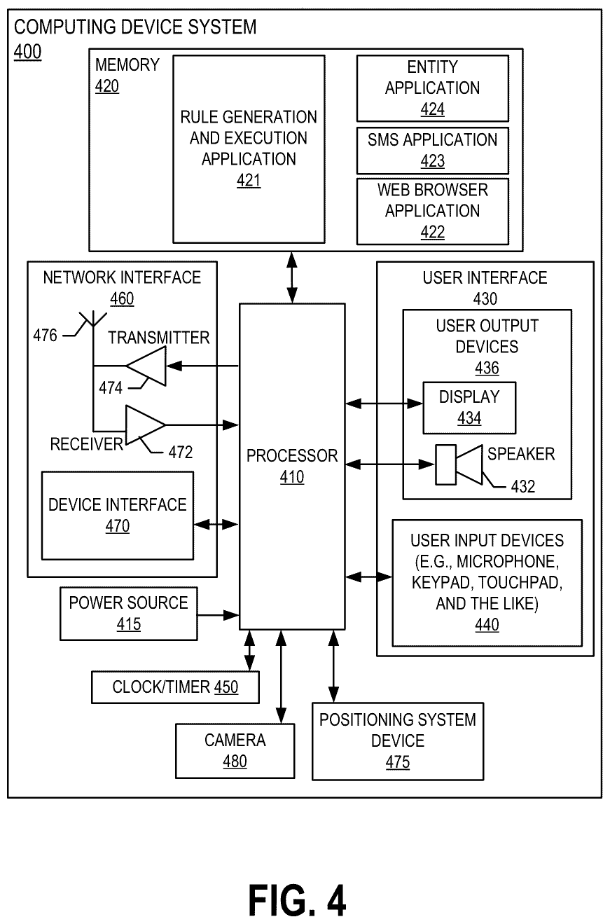

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 434 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an rule generation and execution application 421, entity application 424, an SMS application 423, or the like. In some embodiments, the entity application 424 may be an online banking application. The rule generation and execution application 421 may comprise instructions to a graphical user interface (GUI) on the display 434 that allows the user 110 to interact with the entity system 200, the rule generation and execution system 300, and/or other devices or systems. The memory 420 of the computing device system 400 may comprise a Short Message Service (SMS) application 423 configured to send, receive, and store data, information, communications, alerts, and the like via the wireless network 150. In some embodiments, the rule generation and execution application 421 provided by the rule generation and execution system 300 allows the user 110 to access the rule generation and execution system 300. In some embodiments, the entity application 424 provided by the entity system 200 and the rule generation and execution application 421 allow the user 110 to access the functionalities provided by the rule generation and execution system 300 and the entity system 200. In some embodiments, the entity application 424 may be an online banking application.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a block diagram illustrating a process flow 500 for performing exposure assessment to automatically generate and execute rules associated with allocation of resources, in accordance with an embodiment of the invention. In some embodiments, the process flow described herein may be applied to rule generation associated with generation and execution of any smart contracts that are based on collection of sensor data and are not solely limited to smart contracts associated with allocation or disbursements of resources associated with acquisition of units. Examples of such cases may comprise insurance contracts, execution of smart contracts associated with finalizing bank account to executors of the bank account of a customer, and/or the like.

As shown in block 505, the system receives a request for allocation of resources from a user, where the allocation of resources is associated with acquisition of a unit. In some embodiments, the request may be initiated by a user associated with an entity. For example, the user may be a customer of an entity (entity associated with the entity system 200) associated with the system of the invention. In some embodiments, the request may be initiated by a user not associated with the entity. In some embodiments, the request may be initiated by a user associated with a third party entity (e.g., employee or customer of a third party entity). In some embodiments, the request may be initiated by a third party entity. For example, an organization may initiate a request for allocation of resources towards purchase of a fleet of fleet of aircrafts. In some embodiments, the request may be associated with mere execution of a smart contract associated with any process (e.g., allocation of resources, execution of closure of accounts, execution of insurance terms, and/or the like). In some embodiments, the one or more units may be operational units. In some embodiments, the one or more units may be non-operational units. Examples of units may comprise, but are not limited to, automobiles, aircrafts, appliances, machinery, electronic devices, units comprising perishable products (e.g., perishable food products like caviar) or non-perishable products (e.g., container with paintings), properties such as land, house, or the like, etc. In one example, the allocation of resources request may be associated with acquiring a shipment unit comprising expensive paintings. In another example, the request may be associated with executing terms of insurance contract of an electronic device. In another example, the request may be associated with executing terms of insurance payments.

As shown in block 510, the system prompts the user to register the unit. Registering the unit may comprise the user providing registration information associated with the unit and the system storing the registration information. For example, if the unit is an automobile, the user may provide a vehicle identification number, make, model, and/or the like associated with the automobile and may register the automobile with the system of the invention.

As shown in block 515, the system gathers unit information associated with the unit. The system may gather the unit information associated with the unit based on the registration information associated with the unit. In some embodiments, the system may gather the unit information based on performing one or more of communicating with third party entity systems associated with the unit to extract the information associated with the unit and communicating with one or more sensors associated with the unit to extract the information associated with the unit in real-time. Continuing with the previous example, the system may communicate with the third party entities associated with manufacturing of the automobile to gather specifications of the automobile based in the vehicle identification number. In an example, where the unit is an aircraft, the system may establish a communication link with one or more sensors of the aircraft to gather information associated with the aircraft which may include, but is not limited to, specifications of the aircraft, conditions of the aircraft, usage of the aircraft, and/or the like. In some embodiments, the one or more sensors may be part of the unit. For example, where the unit is an aircraft, machinery, automobile, and/or the like, the one or more sensors may be a part of the unit. In some embodiments, the one or more sensors may be external sensors linked with the unit. For example, where the unit is a shipment container, there may be external sensors that are installed on the container that provide information (humidity, climate, etc.) associated with the container. In some embodiments, the system may communicate with external systems to extract data associated with the unit based on the registration information provided by the user.

As shown in block 520, the system anonymizes the unit information and transmit the anonymized unit information to an artificial intelligence engine. In some embodiments, the artificial intelligence engine may be a Neurosymbolic Artificial Intelligence engine. Neurosymbolic AI engine combines the strengths of neural networks and symbolic reasoning by merging the data-driven power of neural networks with the logic-based reasoning and structured knowledge representation of symbolic AI. Neurosymbolic AI engine instead of reacting to isolated data points, it reasons about the context. For example, a vibration sensor might detect an anomaly in a machine. The neuro-symbolic AI, however, goes beyond the single data point and considers the specific type of machine and its historical vibration patterns, the potential cause of the anomaly based on the type of vibration, the impact of the anomaly on the machine's functionality and potential downtime, the availability and cost of replacement parts, and industry trends and potential disruptions that might affect the machine's value. By considering the broader context, the Neurosymbolic AI generates more informed and nuanced rules that are tailored to the specific use case associated with the smart contract. Anonymizing the data provided to the artificial intelligence may include masking, deleting, and/or the like any sensitive information, personal information, and/or the like form the unit information. In some embodiments, the system may receive anonymized data associated with the unit from one or more data sources and transmit the anonymized data to the artificial intelligence engine for determination of the one or more factors as described below.

As shown in block 525, the system determines, via the artificial intelligence, one or more exposure factors associated with the unit and the allocation of resources towards acquisition of the unit. Determining the one or more exposure factors via the artificial intelligence engine may comprise analyzing the unit information gathered from the one or more sensors and generating one or more exposure factors that weigh rules associated with acquisition of the unit and allocation of resources associated with the acquisition of the unit. The one or more exposure factors associated with (i) the unit and (ii) the allocation of resources towards acquisition of the unit may be associated with condition of the unit, maintenance history of the unit, financial condition of the user initiating the request, and/or the like. For example, the system may determine a maintenance exposure associated with the unit, a unit condition exposure associated with the unit, historical financial exposure associated with the user acquiring the unit, and/or the like.

As shown in block 530, the system dynamically generates one or more rules associated with the allocation of resources associated with the acquisition of the unit based on the one or more exposure factors. The one or more rules may be associated with allocation of resources towards acquisition of the unit (e.g., loan terms, exposure thresholds, and/or the like). In one example, where the request is associated with a loan towards acquisition of an automobile, the system may generate underwriting rules associated with the loan. In some embodiments, the system may also generate adjustments or suggestions to adjustments of loan terms, disbursement of resources, suggestions associated with maintenance of the unit, and/or the like to mitigate exposure factors identified by the system in block 525. In another example, where the request is associated with a smart contract associated with an insurance contract, the system may generate rules associated with execution of the insurance contract. In some embodiments, the system may also generate rules tied with the suggestions generated by the artificial intelligence engine. For example, the system may generate a rule for disbursing a portion of the resources of the loan only after the user completes a critical equipment upgrade identified as necessary through sensor data analysis.

As shown in block 535, the system automatically executes a smart contract associated with the allocation of resources based on the one or more rules associated with the allocation of resources. In some embodiments, the system may execute the smart contract on a distributed register ledger to create an immutable record of the smart contract.

As shown in block 540, the system continues monitoring the unit post execution of the smart contract. The system may continuously communicate with the one or more sensors associated with the unit to monitor the unit. As shown in block 545, the system generates one or more measures associated with the smart contract or the unit based on monitoring the unit. For example, the system may suggest additional maintenance suggestions based on monitoring data collected by the system.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for performing exposure assessment to automatically generate and execute rules associated with allocation of resources, the system comprising:
a memory device with computer-readable program code stored thereon;
a communication device; and
a processing device operatively coupled to the memory device and the communication device, wherein the processing device is configured to execute the computer-readable program code to:
receive a request for allocation of resources from a user, where the allocation of resources is associated with acquisition of a unit;
prompt the user to register the unit;
gather unit information associated with the unit;
anonymize the unit information and transmit the anonymized unit information to an artificial intelligence engine;
determine, via the artificial intelligence engine, one or more exposure factors associated with the unit and the allocation of resources towards acquisition of the unit;
dynamically generate one or more rules associated with the allocation of resources associated with the acquisition of the unit based on the one or more exposure factors; and
automatically execute a smart contract associated with the allocation of resources based on the one or more rules associated with the allocation of resources.

2. The system according to claim 1, wherein the processing device is further configured to execute the computer-readable program code to gather information associated with the unit based on performing one or more of:
communicating with third party entity systems associated with the unit to extract the information associated with the unit; and
communicating with one or more sensors associated with the unit to extract the information associated with the unit in real-time.

3. The system according to claim 2, wherein the one or more sensors are part of the unit.

4. The system according to claim 2, wherein the one or more sensors are external sensors linked with the unit.

5. The system according to claim 2, wherein the processing device is further configured to execute the computer-readable program code to:
monitor the unit via the one or more sensors;
generate one or more measures associated with the smart contract or the unit based on monitoring the unit; and
automatically execute at least one measure of the one or more measures.

6. The system of claim 1, wherein the processing device is further configured to execute the computer-readable program code to:
receive anonymized data associated with the unit from one or more data sources; and
transmit the anonymized data to the artificial intelligence engine for determination of the one or more factors.

7. The system according to claim 1, wherein the unit is an operational unit or a non-operational unit.

8. A computer program product for performing exposure assessment to automatically generate and execute rules associated with allocation of resources, the computer program product comprising at least one non-transitory computer readable medium having computer-readable program code portions embodied therein, the computer-readable program code portions comprising executable portions for:
receiving a request for allocation of resources from a user, where the allocation of resources is associated with acquisition of a unit;
prompting the user to register the unit;
gathering unit information associated with the unit;
anonymizing the unit information and transmit the anonymized unit information to an artificial intelligence engine;
determining, via the artificial intelligence engine, one or more exposure factors associated with the unit and the allocation of resources towards acquisition of the unit;
dynamically generating one or more rules associated with the allocation of resources associated with the acquisition of the unit based on the one or more exposure factors; and
automatically executing a smart contract associated with the allocation of resources based on the one or more rules associated with the allocation of resources.

9. The computer program product of claim 8, wherein the computer-readable program code portions comprising executable portions for gathering information associated with the unit based on performing one or more of:
communicating with third party entity systems associated with the unit to extract the information associated with the unit; and
communicating with one or more sensors associated with the unit to extract the information associated with the unit in real-time.

10. The computer program product of claim 9, wherein the one or more sensors are part of the unit.

11. The computer program product of claim 9, wherein the one or more sensors are external sensors linked with the unit.

12. The computer program product of claim 9, wherein the computer-readable program code portions comprising executable portions for:
monitoring the unit via the one or more sensors;
generating one or more measures associated with the smart contract or the unit based on monitoring the unit; and
automatically executing at least one measure of the one or more measures.

13. The computer program product of claim 8, wherein the computer-readable program code portions comprising executable portions for:
receiving anonymized data associated with the unit from one or more data sources; and
transmitting the anonymized data to the artificial intelligence engine for determination of the one or more factors.

14. A computer-implemented method for performing exposure assessment to automatically generate and execute rules associated with allocation of resources, the method comprising:
receiving a request for allocation of resources from a user, where the allocation of resources is associated with acquisition of a unit;
prompting the user to register the unit;
gathering unit information associated with the unit;
anonymizing the unit information and transmit the anonymized unit information to an artificial intelligence engine;
determining, via the artificial intelligence engine, one or more exposure factors associated with the unit and the allocation of resources towards acquisition of the unit;
dynamically generating one or more rules associated with the allocation of resources associated with the acquisition of the unit based on the one or more exposure factors; and
automatically executing a smart contract associated with the allocation of resources based on the one or more rules associated with the allocation of resources.

15. The computer-implemented method of claim 14, wherein gathering information associated with the unit is based on performing one or more of:
communicating with third party entity systems associated with the unit to extract the information associated with the unit; and
communicating with one or more sensors associated with the unit to extract the information associated with the unit in real-time.

16. The computer-implemented method of claim 15, wherein the one or more sensors are part of the unit.

17. The computer-implemented method of claim 15, wherein the one or more sensors are external sensors linked with the unit.

18. The computer-implemented method of claim 15, wherein the method comprises:
monitoring the unit via the one or more sensors;
generating one or more measures associated with the smart contract or the unit based on monitoring the unit; and
automatically executing at least one measure of the one or more measures.

19. The computer-implemented method of claim 14, wherein the method comprises:
receiving anonymized data associated with the unit from one or more data sources; and
transmitting the anonymized data to the artificial intelligence engine for determination of the one or more factors.

20. The computer-implemented method of claim 14, wherein the unit is an operational unit or a non-operational unit.
